(19) United States
(12) Patent Application Publication
(10) Pub. No.: US 2026/0099699 A1
(43) Pub. Date: Apr. 9, 2026

(54) Semantic Communication Method and Apparatus, Device, and Storage Medium

(71) Applicant: GUANGDONG POWER GRID CO., LTD., Guangzhou, Guangdong (CN)

(72) Inventor: Ying SUN, Guangzhou, Guangdong (CN)

(21) Appl. No.: 18/926,370

(22) Filed: Oct. 25, 2024

Related U.S. Application Data
(63) Continuation-in-part of application No. PCT/CN2023/136428, filed on Dec. 5, 2023.

(30) Foreign Application Priority Data
Oct. 30, 2023 (CN) 202311418393.3

(51) Int. Cl. G06N 3/0455; G06N 3/0464; G06N 3/08

(52) U.S. Cl. CPC G06N 3/0455; G06N 3/0464; G06N 3/08

(57) ABSTRACT

Provided are a semantic communication method and apparatus, a device, and a storage medium. The semantic communication method includes: inputting a to-be-transmitted target model into a preset semantic encoder to output semantic information of the target model; and transmitting the semantic information of the target model to a preset semantic decoder through a wireless channel to output a reconstructed model corresponding to the target model. When the semantic encoder and the semantic decoder are trained, a training sample is selected from a training sample set as a target training sample; and a semantic contrastive loss function of the training sample set is determined with a goal of minimizing a first semantic distance between the target training sample and a corresponding enhanced sample and maximizing a second semantic distance between a remaining training sample and the target training sample to train the semantic encoder and the semantic decoder.

### CROSS REFERENCE TO RELATED APPLICATIONS

The present application is a Continuation-In-Part Application of PCT Application No. PCT/CN2023/136428 filed on Dec. 5, 2023, which claims the benefit of Chinese Patent Application No. 202311418393.3 filed on Oct. 30, 2023. All the above are hereby incorporated by reference in their entirety.

### TECHNICAL FIELD

The present disclosure relates to the technical field of communications, and in particular, to a semantic communication method and apparatus, a device, and a storage medium.

### BACKGROUND

In recent years, as an efficient transmission method for a promising wireless network model, semantic communication has attracted increasing research interests in the academic community. Compared with the traditional communication paradigm based on the Shannon theory, the semantic communication aims to preferentially preserve meaningful semantic information instead of focusing on accuracy of a transmitted symbol, which can significantly reduce an amount of transmitted data and improve communication efficiency.

A main issue in semantic communication of model transmission is how to enable a transmitter to effectively extract semantic information of a model and enable a receiver to accurately reconstruct the semantic information of the model under a limited communication condition. In the existing semantic communication methods, deep learning-based semantic encoding is performed at a transmitting end, semantic information of an input model is extracted, and then corresponding deep semantic decoding is performed at a receiving end to reconstruct the semantic information of the model, thereby significantly reducing an amount of data in communication without affecting semantic information communication.

In a model transmission process, since an original model at the transmitter has the same semantic information as a reconstructed model at the receiver, a semantic distance (also known as a semantic similarity) between the two almost identical models that share the same semantic information should be sufficiently small. However, in the existing semantic communication methods, especially in a fading channel, there is often a large semantic distance between the two almost identical models that share the same semantic information. This cannot effectively reduce the semantic distance between the original model and the reconstructed model, and cannot ensure that transmitted information can better maintain its semantic accuracy in a downstream task, affecting effectiveness of the semantic communication.

### SUMMARY

The present disclosure provides a semantic communication method and apparatus, a device, and a storage medium to solve a technical problem that semantic accuracy of a reconstructed model cannot be ensured due to a large semantic distance between an original model and the reconstructed model in existing semantic communication methods.

To solve the foregoing technical problem, an embodiment of the present disclosure provides a semantic communication method, including:
inputting a to-be-transmitted target model into a preset semantic encoder, which the semantic encoder extracts and outputs semantic information of the target model; and
transmitting the semantic information of the target model to a preset semantic decoder through a wireless channel, which the semantic decoder reconstructs the target model based on the semantic information of the target model and outputs a reconstructed model corresponding to the target model; where
the preset semantic encoder and the preset semantic decoder are pre-trained through contrastive learning (CL), where a specific process includes:
when training the semantic encoder and the semantic decoder, obtaining a training sample set, and selecting a training sample from the training sample set as a target training sample;
using a model damage of the training sample in the wireless channel as a form of data augmentation, determining a first semantic distance between the target training sample and a corresponding enhanced sample of the target training sample, and determining a second semantic distance between a remaining training sample in the training sample set and the target training sample;
determining a semantic contrastive loss function of the training sample set with a goal of minimizing the first semantic distance and maximizing the second semantic distance; and
training the semantic encoder and the semantic decoder based on the training sample set and the semantic contrastive loss function.

As a preferred solution, the semantic encoder extracts and outputs the semantic information of the target model includes:
extracting the semantic information of the target model, and performing nonlinear mapping on the extracted semantic information to generate a k-dim complex-valued vector; and
performing power normalization on the k-dim complex-valued vector, and outputting semantic information of the target model transmitted in the wireless channel; where
the nonlinear mapping is performed on the extracted semantic information according to a following formula:

$$\tilde{s} = {ℰ}_{{θ}_{1}} ( x )$$

where \tilde{s} represents the k-dim complex-valued vector, ε_{θ}_{₁}(⋅) represents a semantic encoding operation of a parameter θ₁, and x represents the target model; and
the power normalization is performed on the k-dim complex-valued vector according to a following formula:

$$s = \sqrt{kP} \frac{\tilde{s}}{\sqrt{\tilde{{s}^{*} \tilde{s}}}}$$

where s represents the semantic information of the target model transmitted in the wireless channel, k represents a bandwidth of the wireless channel, P represents average power of a semantic information transmitting end, and * represents conjugate transposition.

As a preferred solution, the reconstructing the target model based on the semantic information of the target model and outputting a reconstructed model corresponding to the target model includes:
performing semantic decoding on the semantic information of the target model to obtain the reconstructed model corresponding to the target model, where
the semantic decoding is performed on the semantic information of the target model according to a following formula:

$$\hat{x} = {𝒟}_{{θ}_{2}} ( \hat{s} )$$

where \hat{x} represents the reconstructed model corresponding to the target model, [symbol] _{θ}_{₂}(⋅) represents a semantic decoding operation of a parameter θ₂, and ŝ represents semantic information of the target model received by a semantic information receiving end of the semantic decoder.

As a preferred solution, the semantic encoder is a convolutional neural network (CNN) model; and
the CNN model includes: a head convolution, a plurality of downsampling modules, and a channel encoding module, where the downsampling modules each include: a ResBolck module and a convolution for downsampling the target model; and the ResBolck module is a fundamental module in a residual network (ResNet).

As a preferred solution, the semantic decoder is a CNN model; and
the CNN model includes: a head convolution, a plurality of upsampling modules, and a recoding module, where the upsampling modules each include a ResBolck module and a Pixel-Shuffle module for upsampling the target model; and the ResBolck module is a fundamental module in a ResNet.

As a preferred solution, the determining a first semantic distance between the target training sample and a corresponding enhanced sample of the target training sample, and determining a second semantic distance between a remaining training sample in the training sample set and the target training sample includes:
inputting the target training sample into the semantic encoder, which the semantic encoder extracts and outputs semantic information of the target training sample;
transmitting the semantic information of the target training sample to the semantic decoder through the wireless channel, which the semantic decoder reconstructs the target training sample based on the semantic information of the target training sample and outputs a corresponding reconstructed sample model corresponding to the target training sample as the enhanced sample of the target training sample;
generating a feature map for each of the target training sample, the enhanced sample, and the remaining training sample in the training sample set;
through a preset projection network, mapping the feature map of the target training sample to a preset semantic space to obtain a first projection result, mapping the feature map of the enhanced sample to the semantic space to obtain a second projection result, and mapping the feature map of the remaining training sample in the training sample set to the semantic space to obtain a third projection result;
determining the first semantic distance between the target training sample and the corresponding enhanced sample of the target training sample based on a cosine similarity between the first projection result and the second projection result; and
determining the second semantic distance between the remaining training sample in the training sample set and the target training sample based on a cosine similarity between the first projection result and the third projection result.

As a preferred solution, the training the semantic encoder and the semantic decoder based on the training sample set and the semantic contrastive loss function includes:
performing first-stage training and second-stage training on the semantic encoder and the semantic decoder based on the training sample set and the semantic contrastive loss function, where
the first-stage training includes:
determining a model reconstruction loss function based on a reconstruction loss between the training sample in the training sample set and a corresponding reconstructed sample model of each training sample; and
determining a first loss function based on the model reconstruction loss function and the semantic contrastive loss function, and then performing the first-stage training on the semantic encoder and the semantic decoder based on the first loss function, where
the first loss function is as follows:

$${L}_{1} = {α}_{1} {ℒ}_{rec} + ( 1 - {α}_{1} ) {ℒ}_{sem}$$

where α₁∈[0,1], which is a hyperparameter for controlling a trade-off between the model reconstruction loss function and the semantic contrastive loss function, [symbol] _{rec} represents the model reconstruction loss function, and [symbol] ₛₑₘ represents the semantic contrastive loss function; and
the second-stage training includes:
determining a downstream task loss function based on the model damage in the wireless channel;
determining a second loss function based on the downstream task loss function and the model reconstruction loss function, and then performing the second-stage training on the semantic encoder and the semantic decoder based on the second loss function, where
the second loss function is as follows:

$${L}_{2} = {α}_{2} {ℒ}_{rec} + ( 1 - {α}_{2} ) {ℒ}_{Task}$$

where α₂ ∈[0,1], which is a hyperparameter for controlling a trade-off between the downstream task loss function and the model reconstruction loss function, [symbol] _{rec} represents the model reconstruction loss function, and [symbol] _{Task} represents the downstream task loss function.

Based on the above embodiment, another embodiment of the present disclosure provides a semantic communication apparatus, including a semantic encoding module, a semantic decoding module, and a model training module, where
the semantic encoding module is configured to input a to-be-transmitted target model into a preset semantic encoder, which the semantic encoder extracts and outputs semantic information of the target model;
the semantic decoding module is configured to transmit the semantic information of the target model to a preset semantic decoder through a wireless channel, which the semantic decoder reconstructs the target model based on the semantic information of the target model and outputs a reconstructed model corresponding to the target model; and
the model training module is configured to train the semantic encoder and the semantic decoder through CL, and a specific process includes:
when training the semantic encoder and the semantic decoder, obtaining a training sample set, and selecting a training sample from the training sample set as a target training sample;
using a model damage of the training sample in the wireless channel as a form of data augmentation, determining a first semantic distance between the target training sample and a corresponding enhanced sample of the target training sample, and determining a second semantic distance between a remaining training sample in the training sample set and the target training sample;
determining a semantic contrastive loss function of the training sample set with a goal of minimizing the first semantic distance and maximizing the second semantic distance; and
training the semantic encoder and the semantic decoder based on the training sample set and the semantic contrastive loss function.

Based on the above embodiments, still another embodiment of the present disclosure provides an electronic device, including a processor, a memory, and a computer program stored in the memory and configured to be executed by the processor. The processor executes the computer program to implement the CL-based semantic communication method in the above embodiment of the present disclosure.

Based on the above embodiments, still another embodiment of the present disclosure provides a storage medium, including a stored computer program. When being run, the computer program controls a device in which the storage medium is located to perform the CL-based semantic communication method in the above embodiment of the present disclosure.

Compared with the prior art, the embodiments of the present disclosure have following beneficial effects:

In the present disclosure, a to-be-transmitted target model is input into a preset semantic encoder, such that the semantic encoder outputs semantic information of the target model. The semantic information of the target model is transmitted to a preset semantic decoder through a wireless channel, such that the semantic decoder outputs a reconstructed model corresponding to the target model. The semantic encoder and the semantic decoder are pre-trained through CL. When the semantic encoder and the semantic decoder are trained, a training sample is selected from a training sample set as a target training sample. A model damage of the training sample in the wireless channel is used as a form of data augmentation, a first semantic distance between the target training sample and a corresponding enhanced sample of the target training sample is determined, and a second semantic distance between a remaining training sample and the target training sample is determined. A semantic contrastive loss function of the training sample set is determined with a goal of minimizing the first semantic distance and maximizing the second semantic distance. The semantic encoder and the semantic decoder are trained based on the semantic contrastive loss function.

The present disclosure trains the semantic encoder and the semantic decoder through the CL. The semantic contrastive loss function is determined with the goal of minimizing the first semantic distance between the target training sample and the corresponding enhanced sample of the target training sample and maximizing the second semantic distance between the remaining training sample and the target training sample. Then, the semantic encoder and the semantic decoder are trained based on the semantic contrastive loss function. This can effectively reduce a semantic distance, namely a semantic similarity, between an original model and a reconstructed model, and ensure that transmitted information can better maintain its semantic accuracy in a downstream task, greatly improving an effect of semantic communication.

### BRIEF DESCRIPTION OF THE DRAWINGS

FIG. 1 is a schematic flowchart of a semantic communication method according to an embodiment of the present disclosure;

FIG. 2 is a model architecture diagram of a semantic encoder and a semantic decoder according to the present disclosure;

FIG. 3 is a frame diagram of semantic contrastive encoding according to the present disclosure;

FIG. 4 compares accuracy of the present disclosure and other methods when there are different bandwidth compression ratios and other parameter conditions are the same;

FIG. 5 compares peak signal-to-noise ratios (PSNRs) of the present disclosure and other methods when there are different bandwidth compression ratios and other parameter conditions are the same;

FIG. 6 compares accuracy of the present disclosure and other methods when there are different bandwidth compression ratios and other parameter conditions are the same under a low channel condition;

FIG. 7 compares PSNRs of the present disclosure and other methods when there are different bandwidth compression ratios and other parameter conditions are the same under a low channel condition;

FIG. 8 visually compares the present disclosure and other methods on a Kodak dataset; and

FIG. 9 is a schematic structural diagram of a semantic communication apparatus according to an embodiment of the present disclosure.

### DETAILED DESCRIPTION

The technical solutions in the embodiments of the present disclosure are clearly and completely described below with reference to the accompanying drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure.

### Embodiment 1

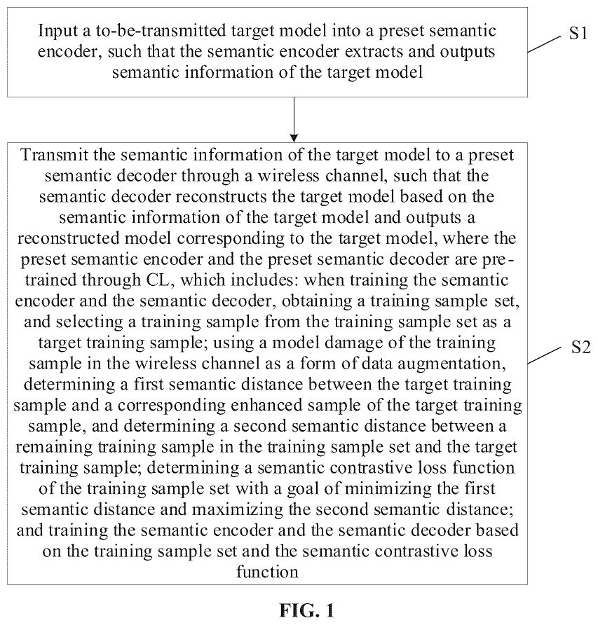

FIG. 1 is a schematic flowchart of a semantic communication method according to an embodiment, present disclosure. The semantic communication method includes following specific steps:

S1: Input a to-be-transmitted target model into a preset semantic encoder, such that the semantic encoder extracts and outputs semantic information of the target model.

The present disclosure first deploys a semantic encoder that is based on CL and a CNN at a semantic information transmitting end, and deploys a semantic decoder that is based on the CL and the CNN at a semantic information receiving end. The semantic encoder extracts and outputs the semantic information of the input target model.

S2: Transmit the semantic information of the target model to a preset semantic decoder through a wireless channel, such that the semantic decoder reconstructs the target model based on the semantic information of the target model and outputs a reconstructed model corresponding to the target model.

The semantic encoder and the semantic decoder are pre-trained through the CL. Specifically, when the semantic encoder and the semantic decoder are trained, a training sample set is obtained, and a training sample is selected from the training sample set as a target training sample. A model damage of the training sample in the wireless channel is used as a form of data augmentation, a first semantic distance between the target training sample and a corresponding enhanced sample of the target training sample is determined, and a second semantic distance between a remaining training sample in the training sample set and the target training sample is determined. A semantic contrastive loss function of the training sample set is determined with a goal of minimizing the first semantic distance and maximizing the second semantic distance. The semantic encoder and the semantic decoder are trained based on the training sample set and the semantic contrastive loss function.

After the semantic encoder outputs the semantic information of the target model, the semantic information of the target model is wirelessly transmitted to the semantic decoder through a wireless fading channel. Then, the semantic decoder reconstructs the target model based on the semantic information of the target model and outputs the reconstructed model corresponding to the target model.

However, in the process of extracting the semantic information of the model, transmitting the model, and reconstructing the model, there is often a very large semantic distance between the original model and the reconstructed model in the prior art, which cannot ensure semantic accuracy of the reconstructed model and thus affects an effect of semantic communication.

In order to reduce the semantic distance between the original model and the reconstructed model, and improve the semantic accuracy of the reconstructed model, the present disclosure establishes a semantic communication system for transmitting a wireless large mode. The semantic encoder and the semantic decoder that are based on the CNN are respectively deployed in a transmitter and a receiver. The deployment of the semantic encoder and the semantic decoder and the construction of the semantic communication system are completed through following main parts:

Preferably, the semantic encoder extracts and outputs the semantic information of the target model includes: extracting the semantic information of the target model and performing nonlinear mapping on the extracted semantic information to generate a k-dim complex-valued vector; and performing power normalization on the k-dim complex-valued vector to output semantic information of the target model transmitted in the wireless channel.

The nonlinear mapping is performed on the extracted semantic information according to a following formula:

$$\tilde{s} = {ℰ}_{{θ}_{1}} ( x )$$

In the above formula, \tilde{s} represents the k-dim complex-valued vector, ε_{θ}_{₁}(⋅) represents a semantic encoding operation of a parameter θ₁, and x represents the target model.

The power normalization is performed on the k-dim complex-valued vector according to a following formula:

$$s = \sqrt{kP} \frac{\tilde{s}}{\sqrt{\tilde{{s}^{*} \tilde{s}}}}$$

In the above formula, s represents the semantic information that the target model transmitted in the wireless channel, k represents a bandwidth of the wireless channel, P represents average power of the semantic information transmitting end, and * represents conjugate transposition.

Preferably, the reconstructing the target model based on the semantic information of the target model and outputting a reconstructed model corresponding to the target model includes: performing semantic decoding on the semantic information of the target model to obtain the reconstructed model corresponding to the target model.

The semantic decoding is performed on the semantic information of the target model according to a following formula:

$$\hat{x} = {𝒟}_{{θ}_{2}} ( \hat{s} )$$

In the above formula, \hat{x} represents the reconstructed model corresponding to the target model, [symbol] _{θ}_{₂}(⋅) represents a semantic decoding operation of a parameter θ₂, and ŝ represents semantic information of the target model received by the semantic information receiving end.

### 1. Deployment of the Semantic Encoder and the Semantic Decoder

(1) Semantic encoder: The semantic encoder is configured to extract semantic information of an input model x∈R^{c×h×w} and directly implement nonlinear mapping from the semantic information to a k-dim complex-valued vector \tilde{s}∈C^{k}. This process is given by a following formula:

$$\tilde{s} = {ℰ}_{{θ}_{1}} ( x )$$

In the above formula, εθ₁(⋅) represents the semantic encoding operation of the parameter θ₁, \tilde{s} represents the k-dim complex-valued vector, x represents the target model, and c, h, and w respectively represent a channel quantity, a height, and a model width.

For simplification, n=c×h×w is used to represent a dimension of x. Usually, a bandwidth constraint can be met only when k<n is met, and k/n is referred to as a bandwidth compression ratio. Particularly, a high bandwidth compression ratio indicates a good communication condition, while a low bandwidth compression ratio indicates limited bandwidth usage. In addition, a power normalization layer needs to be used at a tail end of a semantic encoding network to ensure that average power constraint

$$s = \sqrt{kP} \frac{\tilde{s}}{\sqrt{\tilde{{s}^{*} \tilde{s}}}}$$

at the transmitter. The power normalization operation can be written as follows:

$$\frac{1}{k} [ {s}^{* s} ] \leq P$$

In the above formula, s represents a channel input signal that meets a power constraint, which is the semantic information that is of the target model and transmitted in the wireless channel, k represents the bandwidth of the wireless channel, P represents the average power of the semantic information transmitting end, and * represents the conjugate transposition.

Next, the s is transmitted through an additive white Gaussian (AWGN) channel. This process is given by a following formula:

$$\hat{s} = s + ϵ$$

In the above formula, ŝ represents a received signal, and ϵ∈C^{k} represents an independent and identically distributed (IID) channel noise sample, which follows a symmetric complex Gaussian distribution [symbol] (0, σ²I) with a mean and a variance being σ².

(2) Semantic decoder: The semantic decoder deployed at the receiving end will reconstruct an original model \hat{x}∈R^{c×h×w} from the ŝ, and a reconstruction process is as follows:

$$\hat{x} = {𝒟}_{{θ}_{2}} ( \hat{s} )$$

In the above formula, \hat{x} represents the reconstructed model corresponding to the target model, [symbol] _{θ}_{₂}(⋅) represents the semantic decoding operation of the parameter θ₂, and ŝ represents the semantic information that is of the target model and received by the semantic information receiving end.

Subsequently, the \hat{x} will be used to execute a downstream task and obtain an inference result according to a following process:

$${f}_{x} = {ℱ}_{{ϕ}_{1}}^{b} ( \hat{x} )$$

In the above formula,

$${ℱ}_{{ϕ}_{1}}^{b} ( \cdot )$$

represents a feature extraction operation performed by a CNN backbone for a downstream task, with a parameter φ₁ as a feature, and fₓ={f⁽¹⁾, f⁽²⁾, . . . , f^{(c)}} represents an output feature map with C channels. The fₓ is transferred to a classifier

$${ℱ}_{{ϕ}_{2}}^{cls} ( \cdot )$$

to obtain an inference result ŷ with the parameter φ₂, which can be expressed as follows:

$$\hat{y} = {ℱ}_{{ϕ}_{2}}^{cls} ( {f}_{x} )$$

In the reconstructed model, maintaining the semantic information is crucial for inference performance of the model, especially when the channel bandwidth is limited. Therefore, in the present disclosure, it is crucial to design the semantic encoder and the semantic decoder and subsequently train them according to the above process.

Preferably, the semantic encoder is a CNN model. The CNN model includes: a head convolution, a plurality of downsampling modules, and a channel encoding module. The downsampling modules each include: a ResBolck module and a convolution for downsampling the target model. The ResBolck module is a fundamental module in a residual network (ResNet).

Preferably, the semantic decoder is a CNN model. The CNN model includes: a head convolution, a plurality of upsampling modules, and a recoding module. The upsampling modules each include a ResBolck module and a Pixel-Shuffle module for upsampling the target model. The ResBolck module is the fundamental module in the ResNet.

### 2. Construction of a Semantic Communication Framework

In the present disclosure, a semantic communication framework based on the CL is proposed. A network architecture of the semantic encoder and the semantic decoder plays a crucial role in extracting the semantic information. Therefore, a convolutional layer stacking method in the prior art is not used, as this simple architecture lacks such a capability.

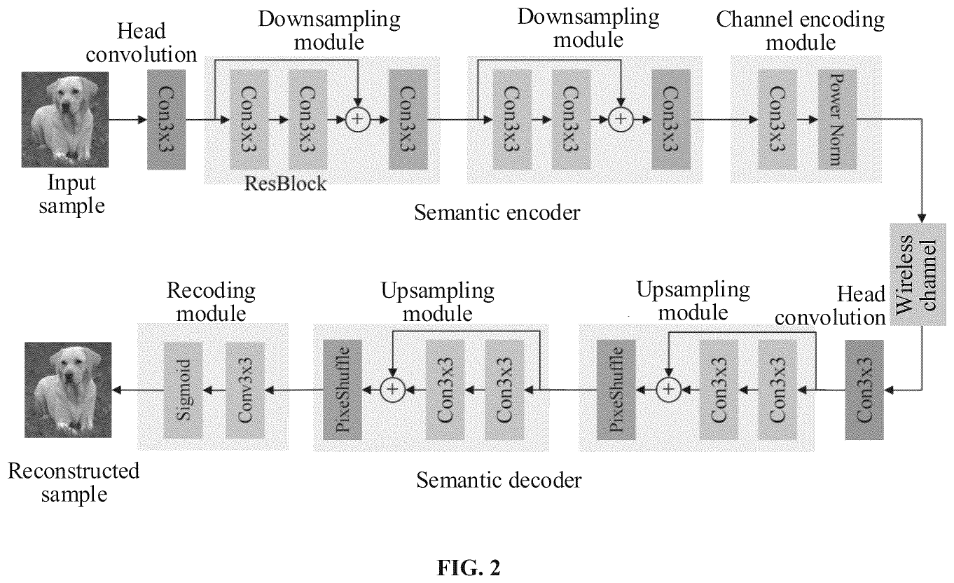

FIG. 2 is a model architecture diagram of the semantic encoder and the semantic decoder in the present disclosure. The semantic encoder includes a 5×5 head convolution, two downsampling modules, and a channel encoding module. Each downsampling module contains one basic block in the ResNet (which is referred to as ResBolck module) for capturing a spatial feature of the model, and one 4×4 convolution for downsampling the model, with a stride of 2.

The channel encoding module is configured to mitigate a channel damage and output a k-dim complex-valued channel input that meets bandwidth and power constraints.

In the semantic decoder, a symmetric architecture is adopted, which is composed of a 5×5 head convolution, two upsampling modules, and a recoding module. In the upsampling module, the ResBolck module is also used, just like in the encoder. Herein, a Pixel-Shuffle technique is used to upsample the model because it can provide a more efficient computational paradigm and better reconstruction performance compared with transposed convolution. The recoding module is constituted by a 3×3 convolution and a Sigmoid activation function, and configured to generate the reconstructed model. It should be noted that if not specified, all convolutions follow batch normalization and a parametric rectified linear unit (PReLU) activation function.

Preferably, the determining a first semantic distance between the target training sample and a corresponding enhanced sample of the target training sample, and determining a second semantic distance between a remaining training sample in the training sample set and the target training sample includes: inputting the target training sample into the semantic encoder, such that the semantic encoder extracts and outputs semantic information of the target training sample; transmitting the semantic information of the target training sample to the semantic decoder through the wireless channel, such that the semantic decoder reconstructs the target training sample based on the semantic information of the target training sample, and outputs a corresponding reconstructed sample model of the target training sample as an enhanced sample of the target training sample; generating a feature map for each of the target training sample, the enhanced sample, and the remaining training sample in the training sample set; through a preset projection network, mapping the feature map of the target training sample to a preset semantic space to obtain a first projection result, mapping the feature map of the enhanced sample to the semantic space to obtain a second projection result, and mapping the feature map of the remaining training sample in the training sample set to the semantic space to obtain a third projection result; determining the first semantic distance between the target training sample and the corresponding enhanced sample of the target training sample based on a cosine similarity between the first projection result and the second projection result; and determining the second semantic distance between the remaining training sample in the training sample set and the target training sample based on a cosine similarity between the first projection result and the third projection result.

### 3. Determining of the Semantic Contrastive Loss Function

A key design of semantic contrastive encoding is inspired by success of the CL. The CL uses the data augmentation to generate samples with similar visual representations and minimizes a distance between the samples to pre-train the backbone. Therefore, in the present disclosure, the CL process can be modified to adapt to the semantic communication system. The data augmentation is replaced with a wireless transmission process because the model damage in the transmission process can be seen as a form of the data augmentation. A small semantic distance between the original model and the reconstructed model should be maintained for an efficient semantic communication system.

In addition, a pre-trained backbone is used to extract features, and these features are mapped to the semantic space by a learnable projection network. Then, in conjunction with a contrastive loss in the semantic space, the semantic encoder and the semantic decoder are jointly optimized, instead of pre-training the backbone during the CL.

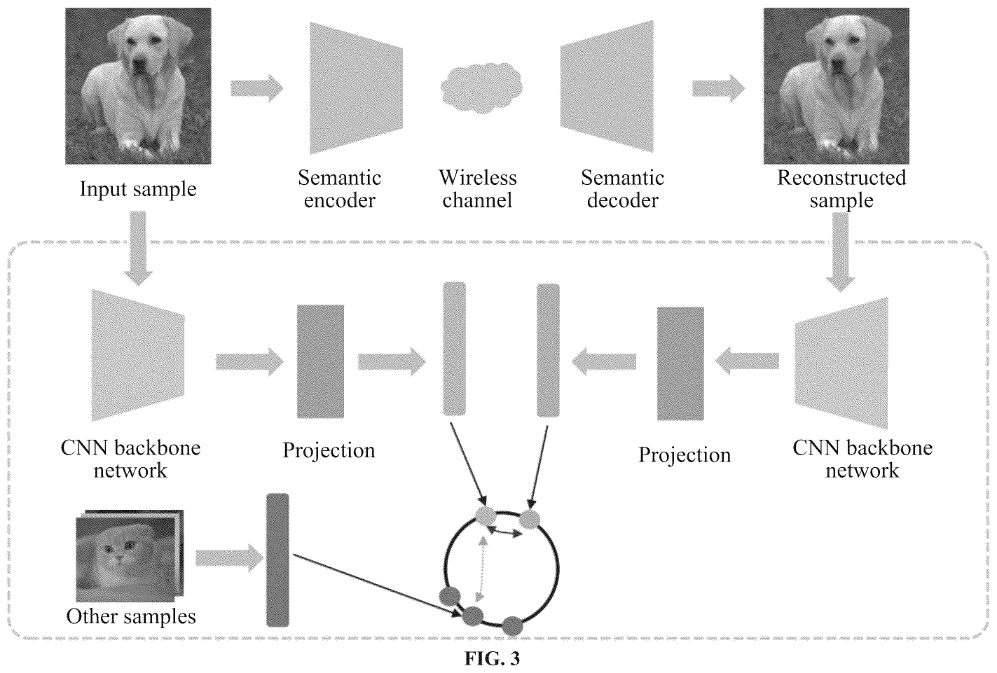

FIG. 3 is a frame diagram of the semantic contrastive encoding according to the present disclosure. In this process, a training sample set [symbol] is obtained first, and a target training sample model x is selected from the [symbol] for semantic encoding and decoding to obtain reconstructed \hat{x} as an enhanced sample model of the target training sample. The backbone network

$${ℱ}_{{ϕ}_{1}}^{b} ( \cdot )$$

is applied to the x and the \hat{x} to generate corresponding feature mappings

$${f}_{x} = {ℱ}_{{ϕ}_{1}}^{b} ( x ) and {f}_{\hat{x}} = {ℱ}_{{ϕ}_{1}}^{b} ( \hat{x} )$$

respectively.

Afterwards, a projection head [symbol] (⋅) is introduced to map the above feature maps to the semantic space, which is achieved through learnable multi-layer perception. Next, through a fully connected projection network [symbol] _{ψ}(⋅) with a learnable parameter ψ and a subsequent normalization operation, the feature is mapped to a semantic space defined as a hypersphere. In a training stage, the [symbol] _{ψ}(⋅) can be updated to enhance understanding of the feature, thereby learning a mapping from the feature to semantics. Specifically, projection results of the fₓ and the f_{\hat{x}} can be represented as qₓ= [symbol] _{ψ}(fₓ) and vₓ= [symbol] _{ψ}(f_{\hat{x}}) respectively, where the qₓ is referred to as anchor, and the v₊ is referred to as positive. A semantic distance between the x and the \hat{x} can be defined by a cosine similarity between the anchor and the positive.

The present disclosure follows the same process for a remaining training sample m∈ [symbol] /{x} in the training sample set [symbol] . The m is input into the backbone network to obtain its corresponding feature map fₘ= [symbol] _{b}(m), and then the fₘ is projected into the semantic space by vₘ= [symbol] _{ψ}(fₘ), where the vₘ is referred to as negative. Similarly, a semantic distance between the x and the m can be defined as a cosine similarity between the anchor and the negative.

A goal of the semantic contrastive encoding is to minimize the semantic distance between the original model and the reconstructed model and maximize a semantic distance between the original model and a competing model. Therefore, a semantic contrastive loss of the training sample set [symbol] can be defined by an InfoNCE function, which can be expressed as follows:

$${ℒ}_{s e m} = {E}_{x ∈ 𝔹} \{ - log \frac{exp ( {q}_{x} \cdot {v}_{+} / τ )}{{\sum }_{m ∈ ℬ / \{ x \}} exp ( {q}_{x} \cdot {v}_{m} / τ )} \}$$

In the above formula, τ>0 represents a temperature coefficient for smoothing a probability distribution.

Preferably, the training the semantic encoder and the semantic decoder based on the training sample set and the semantic contrastive loss function includes: performing first-stage training and second-stage training on the semantic encoder and the semantic decoder based on the training sample set and the semantic contrastive loss function. The first-stage training includes: determining a model reconstruction loss function based on a reconstruction loss between the training sample in the training sample set and a corresponding reconstruction sample model of each training sample; determining a first loss function based on the model reconstruction loss function and the semantic contrastive loss function; and then performing the first-stage training on the semantic encoder and the semantic decoder based on the first loss function.

The first loss function is as follows:

$${L}_{1} = {α}_{1} {ℒ}_{r e c} + ( 1 - {α}_{1} ) {ℒ}_{s e m}$$

In the above function, α₁ ∈[0,1], which is a hyperparameter for controlling a trade-off between the model reconstruction loss function and the semantic contrastive loss function [symbol] _{rec} represents the model reconstruction loss function, and [symbol] ₛₑₘ represents the semantic contrastive loss function.

The second-stage training includes: determining a downstream task loss function based on the model damage in the wireless channel; determining a second loss function based on the downstream task loss function and the model reconstruction loss function; and then performing the second-stage training on the semantic encoder and the semantic decoder based on the second loss function.

The second loss function is as follows:

$${L}_{2} = {α}_{2} {ℒ}_{r e c} + ( 1 - {α}_{2} ) {ℒ}_{T a s k}$$

In the above function, α₂ ∈[0,1], which is a hyperparameter for controlling a trade-off between the downstream task loss function and the model reconstruction loss function, [symbol] _{rec} represents the model reconstruction loss function, and [symbol] _{Task} represents the downstream task loss function.

### 4. Training of the Semantic Encoder and the Semantic Decoder

Next, a loss function and a training process are designed by considering the semantic contrastive encoding and the semantic contrastive loss. Based on the semantic contrastive encoding, a two-stage training strategy is designed to optimize the semantic encoder and the semantic decoder.

(1) First training stage: In this stage, pre-training is performed. Weights of the encoder θ₁, the decoder θ₂, and the project network ψ are simultaneously trained through the semantic contrastive encoding. However, it is difficult to achieve fast convergence when only the semantic contrastive loss is optimized. Therefore, the semantic contrastive loss is combined with a reconstruction loss between the x and the \hat{x}, and the reconstruction loss is reduced to help improve a convergence speed during early training. Specifically, a reconstruction loss of the training sample set [symbol] can be evaluated by a mean square error (MSE) function, which can be expressed as follows:

$${ℒ}_{r e c} = {E}_{x ∈ 𝔹} \{ \frac{1}{n} {‖ x - \hat{x} ‖}_{2}^{2} \}$$

Therefore, a loss function of the first training stage can be summarized as a linear combination, which is given by a following formula:

$${L}_{1} = {α}_{1} {ℒ}_{r e c} + ( 1 - {α}_{1} ) {ℒ}_{s e m}$$

In the above formula, α₁∈[0,1], which is the hyperparameter for controlling the trade-off between the model reconstruction loss function and the semantic contrastive loss function, [symbol] _{rec} represents the model reconstruction loss function, and [symbol] ₛₑₘ represents the semantic contrastive loss function. For example, in a practical semantic communication system, α=k/n can be set. Therefore, in the case of small bandwidth compression, the system preferentially preserves the semantic information instead of considering reconstruction quality. On the contrary, as the bandwidth compression increases, the system shifts its focus to maintaining the reconstruction quality.

(2) Second training stage: The second training stage aims to further optimize performance of the semantic communication system by jointly fine-tuning the encoder, decoder, and the classifier at a small learning rate, in order to achieve considerable inference performance and considerable quality of the reconstructed model. One of reasons for fine-tuning the classifier is that the weights of the backbone network and the classifier are usually trained without considering the channel damage. As a result, an output of the backbone network is added to the reconstructed model instead of the original model. This may decrease the performance. Therefore, using the semantic encoder and the semantic decoder to fine-tune the classifier can alleviate this problem and help enhance semantic transmission. A loss function in this stage can be expressed as follows:

$${L}_{2} = {α}_{2} {ℒ}_{r e c} + ( 1 - {α}_{2} ) {ℒ}_{T a s k}$$

In the above function, α₂ ∈[0,1], which is the hyperparameter for controlling the trade-off between the downstream task loss function and the model reconstruction loss function, [symbol] _{rec} represents the model reconstruction loss function, and [symbol] _{Task} represents the downstream task loss function. Specifically, when the downstream task is a classification problem, a cross entropy function can be used for loss modeling, which is given by a following formula:

$${ℒ}_{T a s k} = {E}_{x ∈ 𝔹} \{ - \frac{1}{{N}_{c l s}} {\sum }_{i = 1}^{{N}_{c l s}} {y}_{i} log ( \hat{{y}_{ι}} ) \}$$

In the above formula, yᵢ and ŷ_{ι} respectively represent a true value and a predicted probability of an i^{th} category. The symbol N_{cls} represents a quantity of categories in a dataset.

FIG. 2 shows the model architecture diagram of the semantic encoder and the semantic decoder according to the present disclosure. In a specific embodiment, in order to verify effectiveness of the proposed framework, an experiment is conducted on CIFAR-10. The framework includes 60,000 32×32 color models classified into 10 categories. A training set contains 50,000 models, and a test set contains 10,000 models. The projection network adopts a two-layer fully connected structure with an output size of 32. Quantities of the training set and the test set in training periods of two replaced stages are set to 200 and 100 respectively, with a batch size of 128. In addition, an Adam optimizer is used, and a learning rate is 0.01 in a first pre-training stage and 0.0001 in a second fine-tuning stage. The learning rate is adjusted every 50 periods with a decay factor of 0.5.

In order to verify performance of the semantic communication framework proposed in the present disclosure, the following contrast experiments are conducted for description:

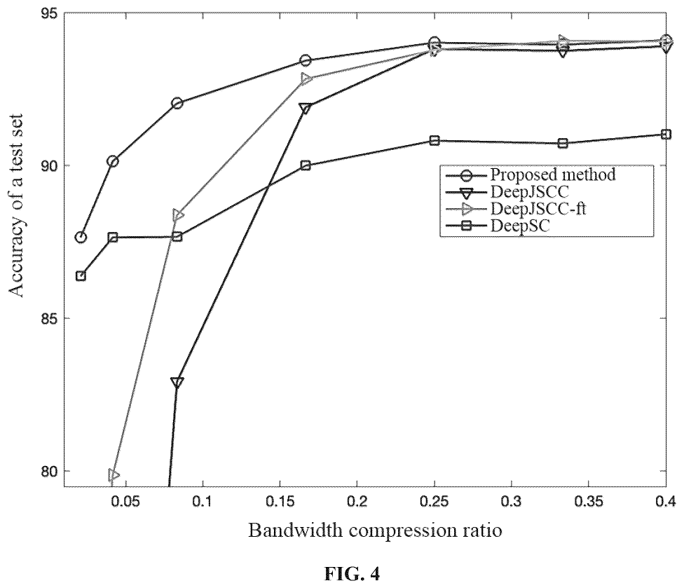

(1) FIG. 4 compares accuracy of the proposed method in the present disclosure and other methods when there are different bandwidth compression ratios and other parameter conditions are the same in a Python simulation environment. From FIG. 4, it can be seen that the proposed method in the present disclosure consistently outperforms or matches other existing methods in terms of accuracy. These results indicate that the semantic communication framework proposed in the present disclosure can effectively extract the semantic information to meet a requirement of the downstream task, and remove irrelevant redundant information to ensure successful transmission of the semantic information, especially when the channel bandwidth is limited.

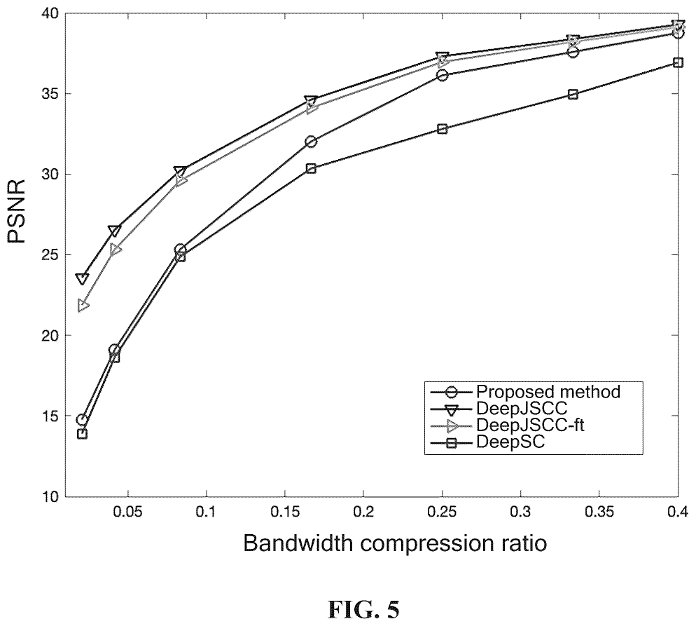

(2) FIG. 5 compares PSNRs of the proposed method in the present disclosure and other methods when there are different bandwidth compression ratios k/n and other parameter conditions are the same in the Python simulation environment. From FIG. 5, it can be found that as the bandwidth compression ratio increases, the PSNRs of all the methods increase. Although the proposed method in the present disclosure sacrifices some model quality to preferentially consider the semantic information when the bandwidth compression ratio is low, the PSNR of the proposed method in the present disclosure can quickly catch up with the PSNR of the DeepJSCC when the bandwidth compression ratio is high. These results indicate that the method can preferentially transmit the semantic information instead of irrelevant background information to ensure performance of the downstream task in a bandwidth limited scenario, and transmit sufficient background information to achieve good model quality when the bandwidth is not an obstacle. This further demonstrates effectiveness of the method.

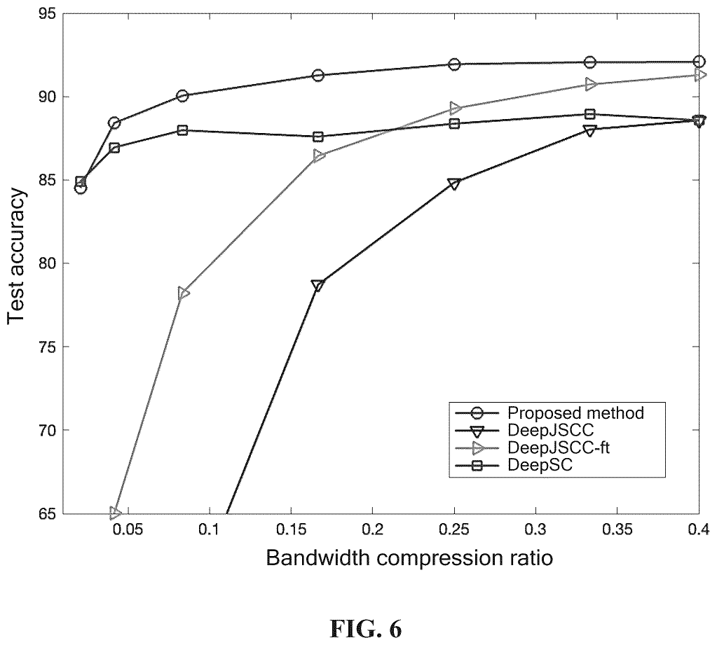

(3) FIG. 6 compares accuracy of the proposed method in the present disclosure and other methods when there are different bandwidth compression ratios and other parameter conditions are the same under a low channel condition in the Python simulation environment. This figure compares accuracy of these methods under a poor channel condition. A low SNR of 5 dB is considered, and the bandwidth compression ratio varies from 1/48 to 1/2.5. From FIG. 6, it can be observed that compared with the other three methods, the proposed method in the present disclosure still shows an advantage in the accuracy, indicating its robustness in a low-SNR scenario.

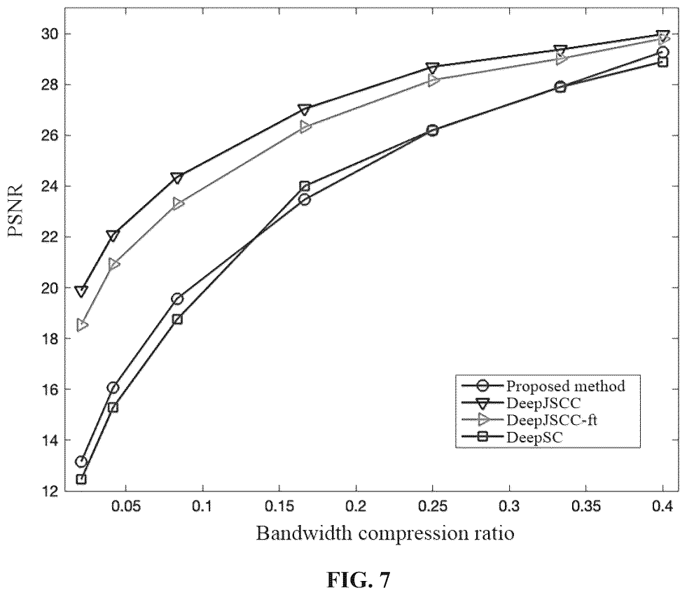

(4) FIG. 7 compares PSNRs of the proposed method in the present disclosure and other methods when there are different bandwidth compression ratios and other parameter conditions are the same under a low channel condition in the Python simulation environment. From FIG. 7, it can be seen that when the bandwidth compression ratio is low, the framework proposed in the present disclosure can adaptively sacrifice global information to achieve comparable semantic performance, and obtain sufficient reconstruction quality in terms of the PSNR as the bandwidth compression ratio decreases. These results in FIG. 7 further validate the effectiveness and robustness of the proposed method in the present disclosure in the low-SNR scenario.

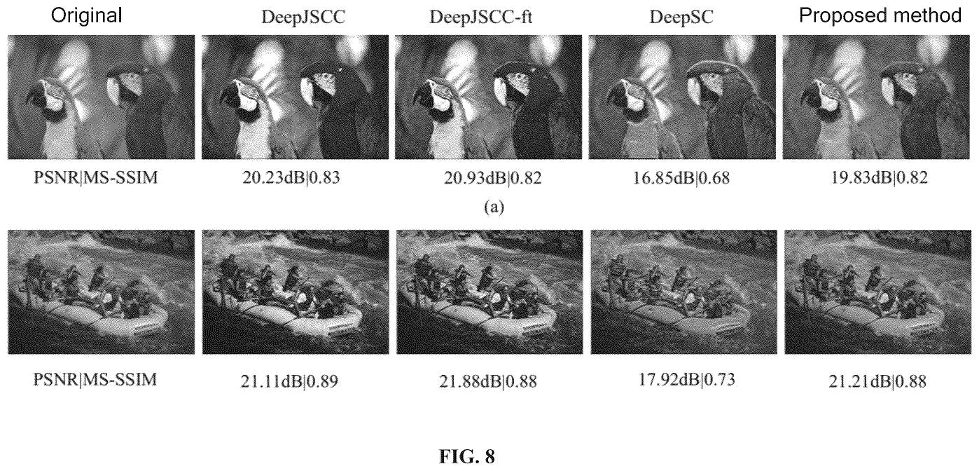

(5) FIG. 8 visually compares the proposed method in the present disclosure and other methods on a Kodak dataset in the Python simulation environment. The encoder and the decoder are trained on an STL10 dataset. From this figure, it can be observed that compared with the compared methods, the proposed method removes the redundant background information while retaining main semantic information, thereby reducing a model damage in a semantic region (such as a macaw and a rafter in the figure). In addition, the proposed method achieves a PSNR and a multi-scale structural similarity (MS-SSIM) that are similar to those of the DeepJSCC and the DeepJSCC-ft, demonstrating its effectiveness in reconstructing the semantic information. These results further demonstrate superiority of the proposed method in the present disclosure in achieving leading accuracy in the downstream task compared with the compared methods.

It can be seen that the present disclosure provides a semantic communication method. The present disclosure can effectively reduce a semantic distance, namely a semantic similarity, between an original model and a reconstructed model, and ensure that transmitted information can better maintain its semantic accuracy in a downstream task, greatly improving an effect of semantic communication. Contrastive learning can provide better model inference performance while maintaining communication efficiency. A loss of the semantic information is overcome through the contrastive learning to ensure that the transmitted information can better maintain its semantic accuracy in the downstream task. A two-stage training process and corresponding loss functions are adopted to achieve a good trade-off between model recognition performance and reconstruction quality in the downstream task, thereby providing a more flexible communication solution.

### Embodiment 2

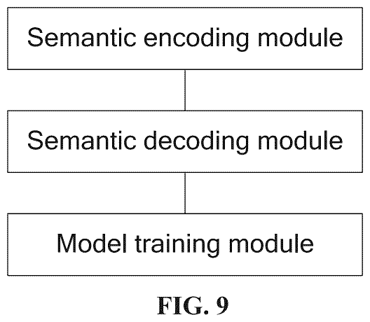

FIG. 9 is a schematic structural diagram of a semantic communication apparatus according to an embodiment of the present disclosure. The semantic communication apparatus includes a semantic encoding module, a semantic decoding module, and a model training module.

The semantic encoding module is configured to input a to-be-transmitted target model into a preset semantic encoder, such that the semantic encoder extracts and outputs semantic information of the target model.

The semantic decoding module is configured to transmit the semantic information of the target model to a preset semantic decoder through a wireless channel, such that the semantic decoder reconstructs the target model based on the semantic information of the target model and outputs a reconstructed model corresponding to the target model.

The model training module is configured to train the semantic encoder and the semantic decoder through CL.

When the semantic encoder and the semantic decoder are trained, a training sample set is obtained, and a training sample is selected from the training sample set as a target training sample.

A model damage of the training sample in the wireless channel is used as a form of data augmentation, a first semantic distance between the target training sample and a corresponding enhanced sample of the target training sample is determined, and a second semantic distance between a remaining training sample in the training sample set and the target training sample is determined.

A semantic contrastive loss function of the training sample set is determined with a goal of minimizing the first semantic distance and maximizing the second semantic distance.

The semantic encoder and the semantic decoder are trained based on the training sample set and the semantic contrastive loss function.

In another implementation example, the above semantic communication apparatus includes a processor. The processor is configured to execute the foregoing program modules stored in a memory, including the semantic encoding module, the semantic decoding module, and the model training module.

It should be noted that the apparatus embodiment described above is merely schematic, where the unit described as a separate component may or may not be physically separated, and a component displayed as a unit may or may not be a physical unit, that is, the component may be located at one place, or distributed on a plurality of network units. Some or all of the modules may be selected based on actual needs to achieve the objectives of the solutions of the embodiments.

In addition, in the accompanying drawing of the apparatus embodiment provided in the present disclosure, a connection relationship between modules represents a communication connection between the modules, which may be specifically implemented as one or more communication buses or signal lines. Those of ordinary skill in the art can understand and implement the embodiments without creative effort.

A person skilled in the art can clearly understand that for convenience and brevity of description, reference may be made to a corresponding process in the foregoing method embodiment for a specific working process of the foregoing apparatus. Details are not described herein again.

### Embodiment 3

Correspondingly, this embodiment of the present disclosure provides an electronic device. The electric device includes a processor, a memory, and a computer program stored in the memory and configured to be executed by the processor. The processor executes the computer program to implement the semantic communication method described in the above embodiment of the present disclosure.

The electronic device may be a computing device such as a desktop computer, a notebook, a palmtop computer, or a cloud server. The electronic device may include, but not limited to, the processor and the memory.

The processor may be a Central Processing Unit (CPU), and may also be another general-purpose processor, a Digital Signal Processor (DSP), an Application Specific Integrated Circuit (ASIC), a Field-Programmable Gate Array (FPGA) or another programmable logic device, a discrete gate, a transistor logic device, a discrete hardware component, or the like. The general-purpose processor may be a microprocessor, or any conventional processor. The processor is a control center of the electronic device, and various parts of the whole electronic device are connected by various interfaces and lines.

### Embodiment 4

Correspondingly, this embodiment of the present disclosure provides a storage medium, including a stored computer program. When be run, the computer program controls a device on which the storage medium is located to execute the semantic communication method in the above embodiment of the present disclosure.

The memory may be configured to store the computer program. The processor implements various functions of the device by running or executing the computer program stored in the memory and invoking data stored in the memory. The memory may mainly include a program storage area and a data storage area. The program storage area may store an operating system, an application program required by at least one function, and the like. The data storage area may store data created by a mobile phone, and the like. In addition, the memory may include a high-speed random access memory, and may further include a non-volatile memory, such as a hard disk, an internal storage, a plug-in hard disk, a Smart Media Card (SMC), a Secure Digital (SD) card, a flash card, at least one magnetic disk storage device, a flash memory device, or another volatile solid-state storage device.

The storage medium is a computer-readable storage medium. The computer program is stored in the computer-readable storage medium. The computer program is executed by a processor to implement steps in the foregoing method embodiments. The computer program includes computer program code, and the computer program code may be in a form of source code, object code, or an executable file, may be in some intermediate forms, or the like. The computer-readable medium may include: any physical entity or apparatus capable of carrying computer program code, a recording medium, a USB disk, a mobile hard disk drive, a magnetic disk, an optical disc, a computer memory, a Read-Only Memory (ROM), a Random Access Memory (RAM), an electrical carrier signal, a telecommunications signal, a software distribution medium, and the like. It should be noted that, the content contained in the computer-readable medium may be added or deleted properly according to the legislation and the patent practice in the jurisdiction. For example, in some jurisdictions, depending on the legislation and the patent practice, the computer-readable medium may not include the electrical carrier signal or the telecommunications signal.

The descriptions above are preferred implementations of the present disclosure. It should be noted that for a person of ordinary skill in the art, various improvements and modifications can be made without departing from the principles of the present disclosure. These improvements and modifications should also be regarded as falling into the protection scope of the present disclosure.

1. A semantic communication method, comprising:
inputting a to-be-transmitted target model into a preset semantic encoder, which the semantic encoder extracts and outputs semantic information of the target model; and
transmitting the semantic information of the target model to a preset semantic decoder through a wireless channel, which the semantic decoder reconstructs the target model based on the semantic information of the target model and outputs a reconstructed model corresponding to the target model; wherein
the preset semantic encoder and the preset semantic decoder are pre-trained through contrastive learning (CL), wherein a specific process comprises:
when training the semantic encoder and the semantic decoder, obtaining a training sample set, and selecting a training sample from the training sample set as a target training sample;
using a model damage of the training sample in the wireless channel as a form of data augmentation, determining a first semantic distance between the target training sample and a corresponding enhanced sample of the target training sample, and determining a second semantic distance between a remaining training sample in the training sample set and the target training sample;
determining a semantic contrastive loss function of the training sample set with a goal of minimizing the first semantic distance and maximizing the second semantic distance; and
training the semantic encoder and the semantic decoder based on the training sample set and the semantic contrastive loss function.

2. The semantic communication method according to claim 1, wherein the semantic encoder extracts and outputs the semantic information of the target model comprises:
extracting the semantic information of the target model, and performing nonlinear mapping on the extracted semantic information to generate a k-dim complex-valued vector; and
performing power normalization on the k-dim complex-valued vector, and outputting semantic information of the target model transmitted in the wireless channel; wherein
the nonlinear mapping is performed on the extracted semantic information according to a following formula:
$$\tilde{s} = {ℰ}_{{θ}_{1}} ( x )$$
wherein \tilde{s} represents the k-dim complex-valued vector, ε_{θ}_{₁}(⋅) represents a semantic encoding operation of a parameter θ₁, and x represents the target model; and
the power normalization is performed on the k-dim complex-valued vector according to a following formula:
$$s = \sqrt{k P} \frac{\tilde{s}}{\sqrt{}}$$
wherein s represents the semantic information of the target model transmitted in the wireless channel, k represents a bandwidth of the wireless channel, P represents average power of a semantic information transmitting end, and * represents conjugate transposition.

3. The semantic communication method according to claim 1, wherein the reconstructing the target model based on the semantic information of the target model and outputting a reconstructed model corresponding to the target model comprises:
performing semantic decoding on the semantic information of the target model to obtain the reconstructed model corresponding to the target model, wherein
the semantic decoding is performed on the semantic information of the target model according to a following formula:
$$\hat{x} = {𝒟}_{{θ}_{2}} ( \hat{s} )$$
wherein \hat{x} represents the reconstructed model corresponding to the target model, [symbol] _{θ}_{₂}(⋅) represents a semantic decoding operation of a parameter θ₂, and ŝ represents semantic information of the target model received by a semantic information receiving end of the semantic decoder.

4. The semantic communication method according to claim 1, wherein the semantic encoder is a convolutional neural network (CNN) model; and
the CNN model comprises: a head convolution, a plurality of downsampling modules, and a channel encoding module, wherein the downsampling modules each comprise: a ResBolck module and a convolution for downsampling the target model; and the ResBolck module is a fundamental module in a residual network (ResNet).

5. The semantic communication method according to claim 1, wherein the semantic decoder is a CNN model; and
the CNN model comprises: a head convolution, a plurality of upsampling modules, and a recoding module, wherein the upsampling modules each comprise a ResBolck module and a Pixel-Shuffle module for upsampling the target model; and the ResBolck module is a fundamental module in a ResNet.

6. The semantic communication method according to claim 1, wherein the determining a first semantic distance between the target training sample and a corresponding enhanced sample of the target training sample, and determining a second semantic distance between a remaining training sample in the training sample set and the target training sample comprises:
inputting the target training sample into the semantic encoder, which the semantic encoder extracts and outputs semantic information of the target training sample;
transmitting the semantic information of the target training sample to the semantic decoder through the wireless channel, which the semantic decoder reconstructs the target training sample based on the semantic information of the target training sample and outputs a reconstructed sample model corresponding to the target training sample as the enhanced sample of the target training sample;
generating a feature map for each of the target training sample, the enhanced sample, and the remaining training sample in the training sample set;
through a preset projection network, mapping the feature map of the target training sample to a preset semantic space to obtain a first projection result, mapping the feature map of the enhanced sample to the semantic space to obtain a second projection result, and mapping the feature map of the remaining training sample in the training sample set to the semantic space to obtain a third projection result;
determining the first semantic distance between the target training sample and the corresponding enhanced sample of the target training sample based on a cosine similarity between the first projection result and the second projection result; and
determining the second semantic distance between the remaining training sample in the training sample set and the target training sample based on a cosine similarity between the first projection result and the third projection result.

7. The semantic communication method according to claim 1, wherein the training the semantic encoder and the semantic decoder based on the training sample set and the semantic contrastive loss function comprises:
performing first-stage training and second-stage training on the semantic encoder and the semantic decoder based on the training sample set and the semantic contrastive loss function, wherein
the first-stage training comprises:
determining a model reconstruction loss function based on a reconstruction loss between the training sample in the training sample set and a corresponding reconstructed sample model of each training sample; and
determining a first loss function based on the model reconstruction loss function and the semantic contrastive loss function, and then performing the first-stage training on the semantic encoder and the semantic decoder based on the first loss function, wherein
the first loss function is as follows:
$${L}_{1} = {α}_{1} {ℒ}_{r e c} + ( 1 - {α}_{1} ) {ℒ}_{s e m}$$
wherein α₁ ∈[0,1], which is a hyperparameter for controlling a trade-off between the model reconstruction loss function and the semantic contrastive loss function, [symbol] _{rec} represents the model reconstruction loss function, and [symbol] ₛₑₘ represents the semantic contrastive loss function; and
the second-stage training comprises:
determining a downstream task loss function based on the model damage in the wireless channel;
determining a second loss function based on the downstream task loss function and the model reconstruction loss function; and
performing the second-stage training on the semantic encoder and the semantic decoder based on the second loss function, wherein
the second loss function is as follows:
$${L}_{2} = {α}_{2} {ℒ}_{r e c} + ( 1 - {α}_{2} ) {ℒ}_{T a s k}$$
wherein α₂ ∈[0,1], which is a hyperparameter for controlling a trade-off between the downstream task loss function and the model reconstruction loss function, [symbol] _{rec} represents the model reconstruction loss function, and [symbol] _{Task} represents the downstream task loss function.

8. A semantic communication apparatus, comprising a semantic encoding module, a semantic decoding module, and a model training module, wherein
the semantic encoding module is configured to input a to-be-transmitted target model into a preset semantic encoder, which the semantic encoder extracts and outputs semantic information of the target model;
the semantic decoding module is configured to transmit the semantic information of the target model to a preset semantic decoder through a wireless channel, which the semantic decoder reconstructs the target model based on the semantic information of the target model and outputs a reconstructed model corresponding to the target model; and
the model training module is configured to train the semantic encoder and the semantic decoder through CL, and a specific process comprises:
when training the semantic encoder and the semantic decoder, obtaining a training sample set, and selecting a training sample from the training sample set as a target training sample;
using a model damage of the training sample in the wireless channel as a form of data augmentation, determining a first semantic distance between the target training sample and a corresponding enhanced sample of the target training sample, and determining a second semantic distance between a remaining training sample in the training sample set and the target training sample;
determining a semantic contrastive loss function of the training sample set with a goal of minimizing the first semantic distance and maximizing the second semantic distance; and
training the semantic encoder and the semantic decoder based on the training sample set and the semantic contrastive loss function.

9. An electronic device, comprising a processor, a memory, and a computer program stored in the memory and configured to be executed by the processor, wherein the processor executes the computer program to implement the semantic communication method according to claim 1.

10. A storage medium, comprising a stored computer program, wherein when being run, the computer program controls a device in which the storage medium is located to perform the semantic communication method according to claim 1.
